(19) United States
(12) Patent Application Publication
(10) Pub. No.: US 2016/0092851 A1
(43) Pub. Date: Mar. 31, 2016

(54) BEVERAGE COMPOSITION SYSTEM

(71) Applicant: Neil Hofmeyr Hablutzel, Cape Town (ZA)

(72) Inventor: Roland William De Berg Hewett, Cape Town (ZA)

(21) Appl. No.: 14/949,867

(22) Filed: Nov. 23, 2015

Related U.S. Application Data
(63) Continuation of application No. PCT/IB2014/061663, filed on May 23, 2014.

(30) Foreign Application Priority Data
May 23, 2013 (ZA) 2013/03747

(51) Int. Cl. G06Q 20/04; G06Q 20/40; G06Q 20/32; G06Q 50/12; G06Q 20/28

(52) U.S. Cl. CPC G06Q 20/0453; G06Q 50/12; G06Q 20/28; G06Q 20/3278; G06Q 20/401

(57) ABSTRACT

A beverage service system is described herein, and may include a payment facility adapted to receive a payment from a user and load the payment electronically, as a credit for cup units of a beverage, against a user profile created by the user, the user having a near field communication (NFC)-enabled device linked to their user profile, and a beverage dispenser connected to a computer processor. The system may further include a credit receipt circuit in operative communication with the processor and having at least one reader provided in an immediate vicinity of the beverage dispenser, wherein the system is configured to dispense a cup unit of a beverage into each of a plurality of cups respectively having an electronically detectable, unique identification tag on transmission to the at least one credit receipt reader of a request to redeem a cup credit.

### CROSS-REFERENCE TO RELATED APPLICATIONS

The present application claims the benefit under 35 U.S.C. §365(c) and 35 U.S.C. §120 of PCT International Patent Application No. PCT/IB2014/061663 in the name of Neil Hofmeyer Hablutzel, filed May 23, 2014, pending, which in turn claims priority of South African Provisional Pat. Appl. Ser. No. 2013/03747 in the name of Neil Hofmeyer Hablutzel, filed May 23, 2013, pending. The entire contents of each application is hereby incorporated by reference herein.

### BACKGROUND

1. Field

The example embodiments in general are directed to a beverage service system, more particularly to a system which is adapted to serve users thereof via communication with Near-Field Communication (NFC)-enabled devices of the users.

2. Related Art

At large scale events, such as sporting matches or concerts at large stadium venues, the supply of a keg drinking beverage, namely beer offered on tap and/or a carbonated soft drink, usually constitutes the largest beverage sales at the event. This offers many challenges. Service counters with operators manning on tap drink dispensers are the norm. The barmen take orders, pour the drinks and collect the relevant payment, which is usually or often in cash and requires return of the correct change.

What appears to be a simple transaction is actually relatively time consuming. The steps must nonetheless be carried out and there is little room to speed up each customer interaction. At large events, this often results in long queues and time lost to consumers waiting in them. Thus, the consumer oft-times misses out on part of the event being attended. The problem is even aggravated where spectator events are structured around breaks. These periods see an influx in queuing at the drink counters.

### SUMMARY

An example embodiment of the present invention is directed to a beverage service system, and may include a payment facility adapted to receive a payment from a user and load the payment electronically, as a credit for cup units of a beverage, against a user profile created by the user, the user having a near field communication (NFC)-enabled device linked to their user profile, and a beverage dispenser connected to a computer processor. The system may further include a credit receipt circuit in operative communication with the processor and having at least one reader provided in an immediate vicinity of the beverage dispenser, wherein the system is configured to dispense a cup unit of a beverage into each of a plurality of cups respectively having an electronically detectable, unique identification tag on transmission to the at least one credit receipt reader of a request to redeem a cup credit.

Another example embodiment is directed to a beverage service system which may include a payment facility adapted to receive a payment from a user for cup units of a beverage, based on a user profile created by the user, the user having a near field communication (NFC)-enabled device linked to their user profile, a beverage dispenser connected to a computer processor, and a credit receipt circuit in operative communication with the processor and having at least one reader provided in an immediate vicinity of the beverage dispenser. The system is configured to dispense a cup unit of a beverage into at least one cup having an electronically detectable, unique identification tag configured to interact with the at least one reader to request redemption of one or more cup credits. The request to redeem one or more cup credits includes presenting, to the processor via the credit receipt circuit, a cup having the tag authorized to redeem a credit loaded against the user profile.

Another example embodiment is directed to a beverage service system which may include a payment facility adapted to receive a payment from a user for cup units of a beverage, based on a user profile created by the user, the user having a near field communication (NFC)-enabled device linked to their user profile, and a beverage dispenser connected to a computer processor. The system is configured to recognize an authorization interaction between the NFC-enabled device linked to a particular user profile and to an electronically detectable, unique identification tag of at least one cup that is configured to interact with the at least one reader to request redemption of one or more cup credits so as to receive a beverage unit. The system further includes a credit receipt circuit in operative communication with the processor and having at least one reader provided in an immediate vicinity of the beverage dispenser. The request to redeem the one or more cup credits includes presenting, to the processor via the credit receipt circuit, the cup with its the tag authorized to redeem a credit loaded against the user profile.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 shows a schematic overview of a system in accordance with an example embodiment.

FIG. 2 shows an exploded perspective view of a cup useable with the system of FIG. 1.

FIG. 3 shows a side cross-section of the cup.

FIG. 4 shows an enlarged cross-sectional view of a bottom filling valve of the cup.

FIG. 5 shows an authorization interaction and profile credit receipt circuit according to an example embodiment.

FIG. 6 shows an authorization interaction and profile credit receipt circuit according to another example embodiment.

### DETAILED DESCRIPTION

In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

The example embodiments hereafter describe a system 1 configured for service of a beverage to consumers. In an example, the system 1 is suited to handle mass service of a beverage to consumers in a crowd attendant at a large-scale event of the kind hosted at a sports stadium. The event could be a music concert or a sports event, for example.

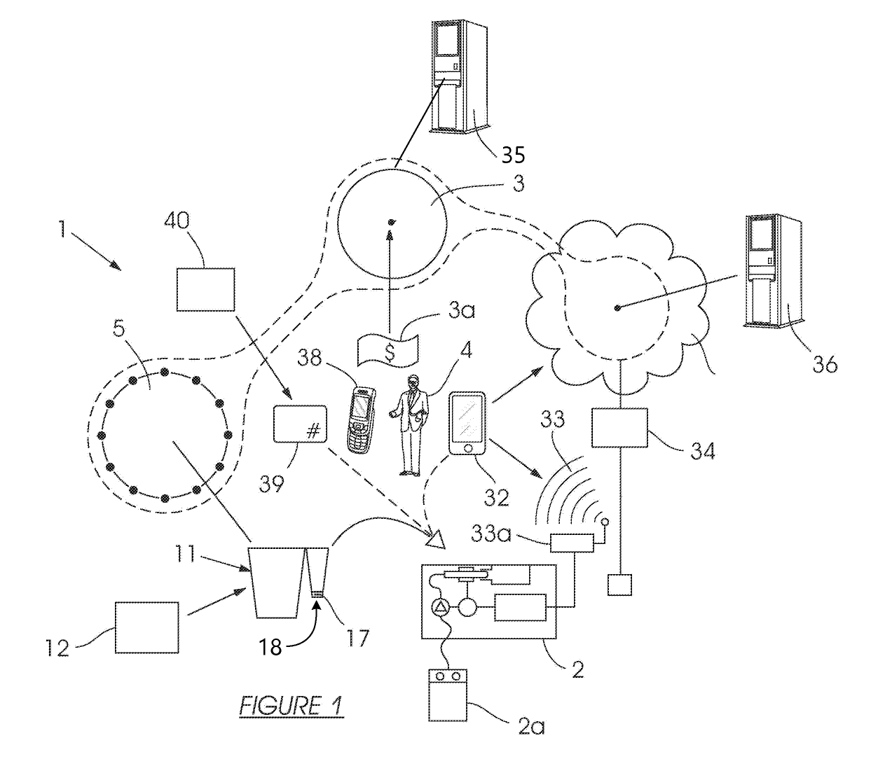

Now referring to FIGS. 1 through 6, there is described a beverage serving system 1 which includes a beverage dispenser or dispensing machine 2. It is the service of keg beer 2a at such events which typically involve considerable logistics, often resulting in significant queuing and delay due to slow processing at beer counters. The example embodiment is described as being implemented with beer dispensers; however it should be appreciated that the example embodiment is applicable to the service of other types of beverages (soft drinks) on tap or from keg 2a. System 1 additionally may include a facility 3 to receive a payment of funds 3a from a consumer of beverages (hereafter referred to as a “user 4”). The facility 3 allows payment to be loaded as a credit for cup units of a beverage, against a user profile 5.

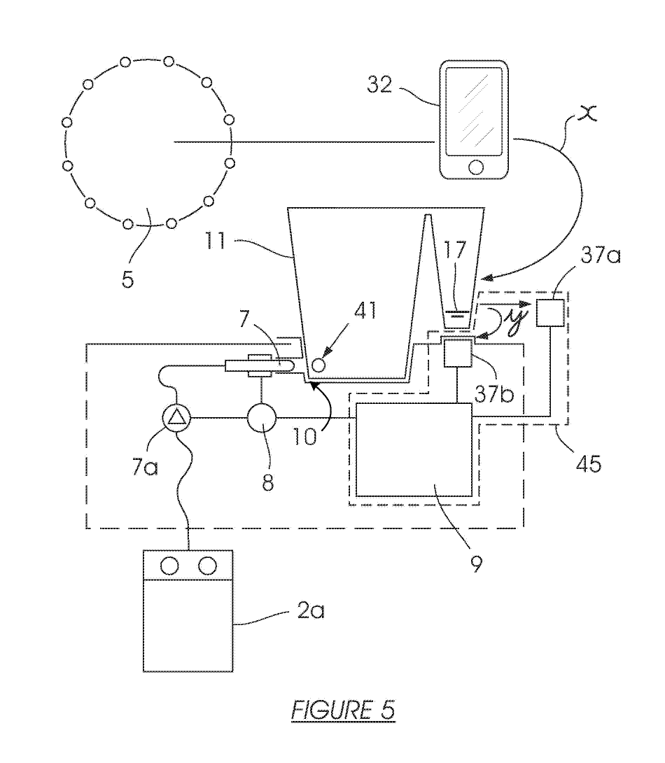

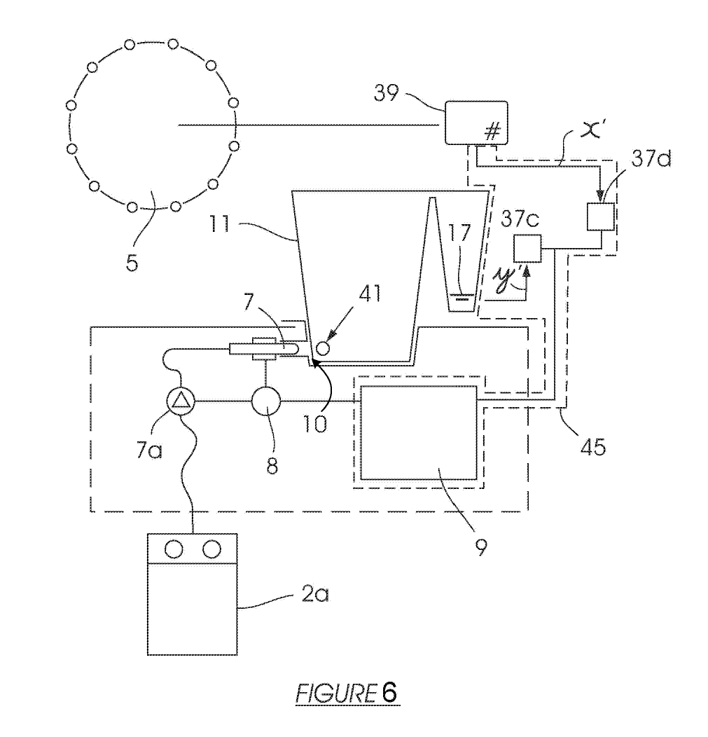

The beverage dispensing machine 2 (hereafter “beverage dispenser 2”) includes a plurality of cup filling stations 6—only one of which is shown in the drawings. Each filling station 6 is provided with a cup filling nozzle 7 having an actuator 8 connected to a computer processor 9 (see FIGS. 5 and 6). Each filling station 6 also has a dock 10 serving as a complementary seat to receive the bottom of a cup 11.

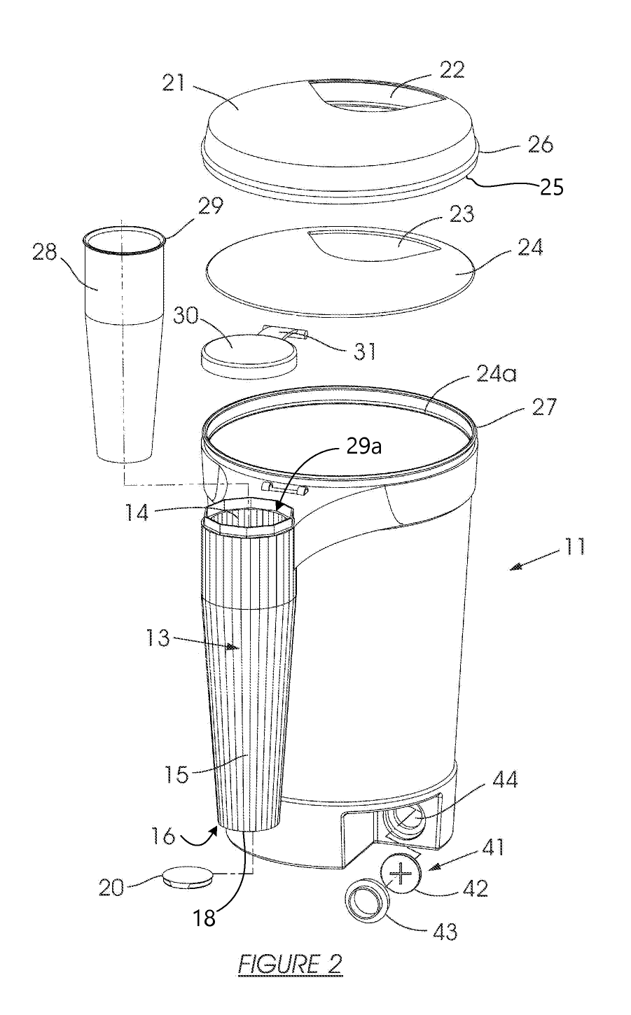

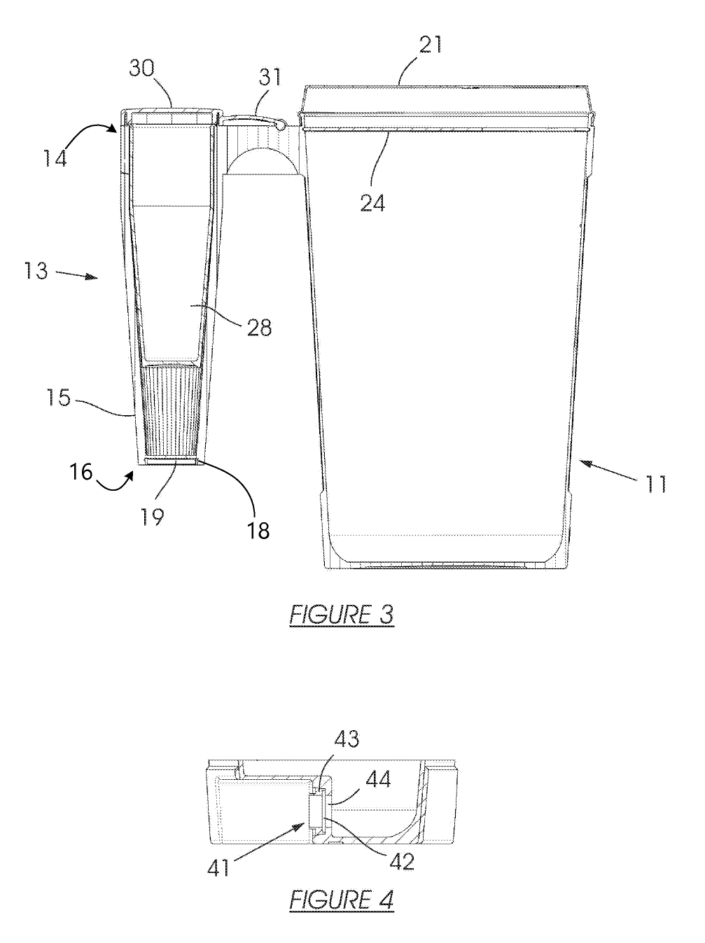

As shown in FIG. 1, a first kiosk 12 may be provided at a strategically selected location, somewhere in the vicinity of the beverage dispenser 2 and/or at entrance gates to the venue grounds. This kiosk 12 serves as a vending machine for automated dispensing of the cups 11 to users 4. In an example, the cups 11 may be molded from suitable plastics or biodegradable material with a filling capacity of approximately 500 ml. In an example, the cups 11 may further be provided with stackable handles 13. As best seen in FIGS. 2 and 3, the handles 13 may include an internal socket 14 extending from an operatively upper end and an external spigot 15 from an operatively lower end 16. The spigot 15 is provided as a complementary fit into an internal socket 14 of another cup 11 for staggered or offset stacking to carry a plurality of beverage-filled cups 11 in a known manner.

In an example, each cup 11 may be fitted with an electronically detectable, unique identification tag 17; see for example FIGS. 1, 5 and 6. The tag 17 may be secured to or against an end wall 18 at the operatively lower end 16 of handle 13. The end wall 18 may be spaced inwardly from the lower end 16. As shown best in FIG. 3, this provides a circular recess 19 within end wall 18 into which the tag 17 can be secured. A cap 20 is provided as an interference or clip fit so as to hold tag 17 in place within the recess 19 of handle 13.

Cup 11 includes a lid 21 with an opening 22 for drinking when aligned with an opening 23 in a closure disk 24. The lid 21 has a skirt 25 with a groove 26 providing a clip-fit to a radial rib 27 formed at the rim of the cup 11. The disk 24 fits into a radial groove 24a on an inner wall of the cup 11 adjacent the rim. The lid 21 can be rotated about the rim of the cup 11. As best shown in FIG. 2, the socket 14 can also be used to store a tot or shooter receptacle 28. A radial flange 29 at the top of the receptacle 28 engages a shoulder 29a within the socket 14 to support the receptacle 28. A closure 30 is provided with an interference fit to the mouth of the socket 14, and is releasably secured to cup 11 by a flexible connector 31.

In one example embodiment, the base or end wall 18 of the cup handle 13 is fitted with an identification tag 17 provided as a Near Field Communication (NFC) readable circuit, such as in the form of an NFC chip. Hereafter for this example embodiment tag 17 shall be referred to as “NFC chip 17”. As shown best in FIG. 5, the NFC chip 17 is adapted to store information (such as credits and vouchers) that is transferred from a user's NFC-enabled mobile telephone 32 (“NFC-capable device”) linked to user profile 5. Additionally, beverage dispenser 2 may integrate NFC technology and a wirelessly supported local area network (LAN), such as Wi-Fi network 33, for communication with suitably enabled mobile telephones 32 of the users 4. In the case where system 1 employs NFC technology, only smart phones 32 configured with internal NFC chips can be used for transactions in the manner set out.

For example, the combination of NFC with Wi-Fi-based communication enables automated payment and filling of cups 11 of beer against user profile 5 credits, and also provides a basis for providing information and transmission of messages to the user 4. The Wi-Fi network 33 employs a captive portal 34 for authentication of users 4 and can be used to send one or more of coupons, vouchers and messages about price specials.

In this example embodiment, the following hardware components suggest what may be required for data processing and connectivity of system 1 (excluding a credit receipt circuit as will be referred to below, which includes an NFC reader):
3× Wi-Fi access points;
1× Wi-Fi controller;
1× basic processor/server 9 with Wi-Fi application installed;
1× Wi-Fi router 33a; and
1× internet connection 46 or 47 (fibre, ADSL or mobile broadband).
   The above components in this example embodiment may be arranged inside a suitable housing, to be incorporated within or at least connected to the beverage dispenser 2. Referring to FIG. 1, a separate database server 36 which manages the changing details and transactions with respect to the user profiles 5 may be provided at a location remote from the stadium/event. The server 36 communicates with system 1 via the internet, designated in FIG. 1 by element 46.

In this example, system 1 initiates interaction with a Wi-Fi-activated mobile telephone 32 of a user 4 upon entry into the Wi-Fi network 33's range. A prompt is be sent to the telephone 32 by system 1, inviting user 4 to join network 33. Upon accepting the request, user 4 is asked to enter their email address, which will be used as a username, and to select and input a user-defined password. The user 4 also is instructed to enter their mobile telephone number.

The new user 4 is then directed to a page to download a mobile application. In this manner, user 4 sets up their user profile 5 on a system database, which is stored on the server 3), to access the service features of the example embodiment. The user 4 thus has an NFC-enabled device ((phone 32) or an alternative communication device as referred to in another example embodiment described hereafter) linked to the user profile 5. The downloaded mobile application allows users 4 to transfer money 3a from their bank accounts to an account linked to the user's profile 5 and to load credits against the profile 5. This payment facility 3 is connected to an electronic platform operated by a server 35 which manages user profiles and profile credits.

Directions will also be provided to activate a cup-mounted NFC chip 17 with a user's NFC-enabled mobile phone 32. Once the user 4 has set up their user profile 5, and with phone 32 connected and money 3a loaded against their profile 5, the mobile phone 32 can be tapped onto the base of a cup's handle 13. This will load the credits from the user profile 5 onto the cup-mounted NFC chip 17.

Beverage dispenser 2 is operated by the computer processor 9, which is enabled by suitable software as is known. The processor 9 controls pouring of the beer/beverage and also records the volume of beer dispensed by the beverage dispenser 2. In an example, a volumetric valve 7a may be included in beverage dispenser 2 to provide measured units of beer per cup. Accordingly, a (beer) dispenser 2 in this example embodiment may be configured with, for example, four filling stations 6, each including the following components:
4× volumetric valves 7a;
4× beverage dispensing nozzles 7; and
1×NFC reader 37a.

As best seen in FIG. 5, the NFC reader 37a activates the beverage dispenser 2 when a cup 11 with NFC chip 17 is tapped onto it or placed within near proximity thereto, as is known in the near field communication arts. Once this is done, user 4 is prompted to hand the cup 11 to a bartender, who will slot it into place on the pouring section of the beer dispenser 2. With the cup 11 in place, the bartender is prompted to push a pour button, which activates the injected nozzle system (nozzle 7) and the beer will be poured or dispensed into the cup 11 from the bottom up. In an example, the prompt may be a simple signal such as a green light.

Alternatively as shown in FIG. 5, another NFC reader 37b may be provided at each filling station 6. This reader 37b is located adjacent dock 10, configured to receive the bottom of a cup 11. When cup 11 is docked, the NFC chip 17 in the base of its handle 13 will be supported within the necessary proximity of NFC reader 37b. As such, a beer dispenser 2 in accordance with this alternative version could, for example, have eight filling stations 6, each of which include the following components:
8× volumetric valves 7a;
8× beverage dispensing nozzles 7; and
8×NFC readers 37b.

Another example embodiment is applicable to users 4 with older mobile telephones 38 that do not have an NFC-embedded chip. For example, and as an alternative to using an NFC-enabled mobile telephone 32, a user 4 is provided with an NFC-enabled device in the form of a card, wrist band or other device provided with a suitable NFC chip. In this embodiment, the device will be an NFC card, indicated generally in FIGS. 1 and 6 by element 39, hereafter referred to hereafter as a “token 39”, or occasionally as “NFC card 39”, and/or “NFC-enabled device 39”. Token 39 may be issued by a second kiosk 40 and may be automatically linked to a relevant user profile 5 or associated/connected account, before the user name and password of the profile 5 are set up. Of note, in a case where an NFC card instead of a token 39 is used, the user profile 5 can still be accessed and managed through a mobile telephone or other suitable communication or data processing device 38. Payments can equally be made to the payment facility 3 using a mobile phone or other suitable device 38.

In addition to access through service provider internet connectivity 46, a local area network will be set up at the stadium. This may conveniently be provided as the Wi-Fi network 33 made available to all profile holders as already referred to. Once user 4 has set up their user profile 5, system 1 is configured so as to link identification tags 17 of cups 11 to the user profile 5, in such cases where such cups 11 were not automatically linked through issue of the token 39 together with cups 11. In this example embodiment, the identification tags may be Radio Frequency Identification (RFID) tags 17 and need not store the information relating to profile credits.

Additionally in this example embodiment, the second kiosk 40 is configured for issuing tokens 39 to users 4. Each token 39 represents a new user profile 5 and includes a unique user profile identifier. The identifier may be as simple as a unique account number or code that represents a user profile 5 which still needs to be set up or personalized, but which is already linked to a RFID tag 17 in a particular cup 11. This can be marked on the exterior of the token or NFC-enabled card 39, or may be readable by a mobile phone (NFC or RFID protocols can be employed depending on the version of the card and a user's mobile phone capabilities). The user 4 then uses the identifier to set up a user profile 5, e.g., selecting a user name and password. For example, an email address or mobile telephone number can conveniently be used as the former and a PIN code as the latter.

Under certain circumstances, it may be convenient to have the first and second kiosks 12, 40 combined as a single station or vending machine. The station may also incorporate a facility to receive payment for cup credits from the user 4. The station is enabled to receive cash, credit/debit cards or other means of payment, such as virtual credit card payments. As before, payment facility 3 is connected to an electronic platform supported by server 35 which manages user profiles and profile credits. In this example embodiment, user 4 has a token/NFC-enabled card 39 linked to their user profile 5.

In addition or as an alternative to the payment station option mentioned above, once a user profile 5 has been set up, a payment facility 3 is provided online available through an internet connection and accessed through the user profile 5. The user profile 5 may be made available by logging in through a portal on an internet webpage or it may be supported by a mobile telephone application involving suitable software downloaded to the consumer/user's mobile telephone or other mobile communication device. Even where a device is not NFC-enabled, the telephone or device includes an interface to access the user profile 5. The interface will in turn provide another option for the payment facility 3 to receive a payment from a user 4 and load that payment against its user profile 5.

The following is direction to various interactions with the beverage dispenser 2 and implementation of other features according to the example embodiments. As described above, the example embodiments provide a system 1 adapted to interact with a plurality of cups 11 having distinct tags (NFC chips or the RFID), which can thus be linked to a single user profile 5. The filling stations 6 are suited for rapid filling of beverage/beer into a cup 11. The volumetric valves 7a in one example may be adapted to dispense 500 ml of beer/beverage. To this end, the stations 6 may be fitted with equipment suited for bottom filling of the cups 11, so as to avoid excessive beer-head formation on rapid filling. This may generally include automated filling nozzles 7 which can fill a cup 11 from the bottom-up.

One option may be for the nozzle 7 to be a retractable nozzle that descends into the cup 11 for filling. In the example embodiments, however, each cup 11 includes a filling valve 41 at or adjacent bottom ends thereof. The nozzle 7 at its filling station 6 penetrates the cup 11 through valve 41. In an example, nozzles 7 are retractable and automated. Additionally in an example (as best shown in FIG. 4), the filling valve 41 includes a resiliently flexible membrane 42 of suitable thickness with a cross or “+” shaped centrally located perforation (not shown). A retaining ring 43 secures the membrane 42 over a nozzle inlet opening 44, with ring 43 making an interference fit into an annular recess countersunk around opening 44. Alternatively, the nozzles 7 could be supported in a fixed position on the filling stations 6. In that case, the cups 11 will be manually fitted onto the nozzles 7 when seated.

The computer processor 9 is connected to and forms part of a profile credit receipt authentication circuit 45, which includes at least one NFC reader 37 provided in the immediate vicinity of the beverage dispenser 2. The processor 9 is also connected to the electronic platform supported by the remote server 36 which manages user profiles 5 and profile credits.

In operation, system 1 operates on the basis of dispensing a cup unit of beverage into each of a plurality of cups 11 respectively having an electronically detectable, unique identification tag 17 on transmission to the credit receipt reader (e.g., any of readers 37a-d) of a request to redeem a cup credit. The request to redeem a cup credit involves presenting, to the processor 9 via the profile credit receipt circuit 45, a cup 11 having the tag 17 authorized to redeem a credit loaded against the user profile 5. Once the cup or cups 11 are filled, the system 1 deducts a commensurate number of credits from the user profile 5 to which the user 4's tag 17 is linked.

But before a request to redeem a cup credit is processed, an authorization interaction (denoted “(xy)”) must take place between the NFC device (32 or 39) linked to a particular user profile 5 and the cup-mounted identification tag 17. The authorization interaction (xy) must be recognized by the system 1 to effect authorization of cups 11 to receive a beverage unit. The authorization interaction (xy) is initiated as a credit transfer instruction (x) executed by the NFC-enabled device (32 or 39).

Referring now to the embodiment described by FIG. 5, the authorization interaction (xy) takes place through series communications (x) and (y). A first interaction (x) takes place between the NFC-enabled device, which is a mobile telephone 32, and the cup-mounted tag, which is NFC chip 17. This first interaction provides the credit transfer instruction (x). The first interaction (x) is a communication provided as a message initiated by the NFC device 32 and transmitted to NFC chip 17. In an example, the first interaction (x) takes place by tapping the cup 11 with the mobile phone 32 to transfer at least one credit to the NFC chip 17 of cup 11. A second interaction (y) then takes place between NFC chip 17 and the credit receipt reader (37a or 37b) which provides the request to redeem a cup credit (y). The second interaction (y) is a communication provided as a message initiated by the tag 17 of cup 11 interacting with a reader (37a or 37b) in the credit receipt circuit 45.

Referring now to the embodiment described by FIG. 6, the authorization interaction (xy) take places through parallel, rather than series communications (x′) and (y′). In this example embodiment, each filling station 6 of the beverage dispenser 2 includes an electronic tag reader 37c as a first reader and an NFC device interrogator 37d as a second reader. Both readers are connected to the computer processor 9 via the credit receipt circuit 45. The NFC device/card/token 39, which represents a user profile 5, and a cup mounted tag (RFID tag 17) linked to the user profile 5 provide a combination of predefined parameters unique to that user profile 5 and to be matched through the credit receipt circuit 45 of the beverage dispenser 2.

Accordingly, in the example embodiment illustrated by FIG. 6, the credit receipt reader 45 includes the first reader 37c to identify a cup mounted tag 17, which may be an RFID tag, and the second reader 37d to receive the credit transfer instruction (y′) from the NFC device, which may be an NFC card 39 (e.g., card with an NFC chip) instead of an NFC-enabled mobile phone. The first communication (x′) is provided as a message from the RFID tag 17 transmitted to the first reader 37c, which provides the request to redeem a cup credit (x′). The second communication (y′) is provided as a message between the NFC device 39 and the second reader 37d, which constitutes the credit transfer instruction (y′).

In light of the aforementioned, system (1) may be thusly programmed to (a) dispense a cup unit of a beverage into each of a plurality of cups 11 respectively having an electronically detectable, unique identification tag 17 on transmission to the credit receipt reader 37a-d of a request to redeem a cup credit; (b) recognize an authorization interaction (xy) between the NFC-enabled device 32/39 linked to a particular user profile 5 and identification tag 17 to effect authorization of cups 11 to receive a beverage unit before processing the request to redeem a cup credit; and (c) deduct a commensurate number of credits from the user profile 5 on dispensing of authorised beverage units.

System 1 accordingly provides for automated payment for filling of a docked cup on actuation of the NFC credit receipt circuit 45 by the user 4's NFC device (32 or 39) and can fill several cups (11) independently on receipt and recognition of the required defined parameters of a user profile 5.

As also noted above, and before an authorization interaction (xy) can take place between the NFC device 32/39 of a particular user profile 5 and any particular cup-mounted tag 17, the tag 17 must first be linked to the user profile 5. This is done by identifying the tag 17 and associating it with a particular user profile 5, or it may take place through a credit transfer instruction with a user NFC device 39 which is connected to the user profile 5. Linking of cup tags 17 to a user profile 5 may also be effected by the vending machine when a cup 11 is initially retrieved. In other words, the user profile 5 is identified to the vending machine before a cup 11 is dispensed and the connection with that profile 5 is established.

Additionally, it is contemplated that the option of transferring credits to a cup 11 that is not linked to a particular user profile 5 will also be available through credit transfer instruction by a user NFC device interaction with that cup 11. This would be subject to reuse limitations of the cup 11, discussed below—a cup mounted tag 17 does not accept more refill credits than the remaining uses or refills that are available to that cup 11, so as to prevent leaking of the valve 41. The linking can also be effected by using a paired combination of readers; that is, one reader 37c on a filling station 6 to detect the cup tag 17 (which is also a request to redeem a cup credit) and a second reader 37d to receive the credit transfer instruction from the NFC device 32/39.

As to the interface on the mobile telephone (applicable to example embodiments) through which the user profile 5 is accessed is contemplated to provide beverage ordering options for a predefined number of cup units. The ordering information relating to the number of cup units required for refill, as selected by option on the interface, may be communicated to the processor 9 for filling of docked cups 11 having tags 17 linked to the user profile. In that case, the order will be processed by the system once the relevant cups 11 are docked and the request to redeem a cup credit is received and the authorization interaction (xy) recognized.

Such communication between a user mobile device 32 linked to the profile 5 and the processor 9 need not take place through the credit receipt circuit 45, but can instead be communicated through the Wi-Fi network 33. The processor 9 is thus notified that a particular user profile 5 seeks to redeem a certain amount of credits and will be in a queue at the beverage dispenser 2. The order is processed when the information required by the credit receipt circuit 45 is received. The pre-order facility of the profile 5 will communicate to the system 1 a current demand for a particular beverage. This may be different brands of beer or soft drinks. With this information, the necessary stock can be made available at the relevant beverage dispensers 2 based on the various locations of the dispensers 2 within the stadium.

In one example, the embodiments noted above may be implemented with respect to cups 11 that are reusable. This is not common practice where beer is served at events of the kind described. Where the cups 11 have bottom filling valves 41, they will be of limited reuse. Penetration of the valves 41 by the filling nozzle 7 tends to damage the valve closure. In this example, it is contemplated that the cups 11 would be reused for five fills only.

The processor 9 of the beverage dispenser 2 is programmed to count uses of individual cups 11 identified by their tags 17. On presentation of a cup 11 after a predetermined number of uses the processor 9 will provide a signal indicating that replacement is required. The signal can be provided through any convenient signal output mechanism, such as a display screen on the dispenser 2 or a simple arrangement of lights (a green light if the cup 11 can be refilled and a red light if the cup 11 has reached the end of its uses and needs to be replaced), for example. Accordingly, processor 9 may be programmed to withhold filling of a docked cup 11 after a predetermined number of uses of the cup 11. A signal is issued for an operator of the beverage dispenser 2 to remove the cup 11 from the dock 10 and insert a replacement cup 11 with a new tag 17. The processor 9 then automatically updates the relevant user profile 5 by linking the new tag 17 of the replacement cup 11. The processor 9 will then also deactivate the tag 17 of the replaced cup 11 from the user profile 5.

It is additionally contemplated that where the cups 11 are not to be automatically replaced by an operator of the dispenser 2, the system 1 will provide a signal to the user 4 providing notification that a replacement cup 11 should be collected from the first kiosk 12. The signal could be communicated through the mobile phone 32 interface accessing the user profile 5 but could alternatively, or in addition, be provided as an SMS to a mobile telephone number linked to the user profile 5.

It is further contemplated that when a cup 11 is initially retrieved from the first kiosk 12, the user 4 will be provided with a payment option up to five refills per cup retrieved—based on the selected number of a five use per cup maximum. Various payment and cup options will be available. For example, a user 4 may want three cups 11 each with three refills available. A signal or message will be sent to the user 4 when the last refill or credit is retrieved. At that stage the user 4 can go back to the first kiosk 12, retrieve another cup 11 with the required number of further credits. The first kiosk 12 may provide various payment options as already mentioned. However, once a user 4 has set up their user profile 5, the payment can be made through a mobile device 32/38 and the cups 11 retrieved from the kiosk 12 using the user 4's NFC-enabled device 32/39.

Moreover, the beverage service system 1 provides for the situation where a user 4 will pour his own beverage as well as where the beer dispensers 2 will be manned by operators behind a bar counter who will pour the beer for the user 4, or at least, place the cup 11 in the filling station 6 and return it once it has been filled. Where beverage dispenser operators are to be used behind a bar counter configuration, the example embodiments further contemplate that each cup filling station 6 may further include a display panel linked through the processor 9 to the first credit receipt readers 37a/c. The display panels might serve to indicate which filling stations 6 have cups 11 linked to a user profile 5 at a particular second credit receipt readers 37b/d provided on or adjacent a countertop for queues of users 4 to access. In an example, the display panels may be arranged for operators of beverage dispensers 32 who are behind the counter to match filled cups 11 for return to users 4 at the respective second credit receipt readers 37b/d.

It is further contemplated that system 1 may include a machine to rinse and/or clean cups 11. In this example a cup 11 would be inverted and pressed down over a cleaning fluid nozzle. A pressure sensitive plate surrounding the nozzle would activate the mechanism. Cleaning liquid will spray out of the nozzle and disinfect the inside of the cup.

Moreover, the invent for further contemplates that a large format display may be used at kiosks or vending machines and/or at the beverage dispensers 2, which would in this example provide directions for cup activation, profile set-up, payment options and cup cleaning.

Among many advantages over conventional beverage delivery devices, system 1 allows for efficient service combined with quick dispensing and avoids money counting at the beverage dispensers 2. In addition to the prepaid pouring of a beverage, the system 1 provides data relating to dispensing of beverage per tagged and identified cup 11. This provides for cashless beverage ordering counters with the possibility of self-service facilities and a comprehensive record of stock usage. The number of cups 11 dispensed and credits purchased may also provide an indication of the expected demand for a beverage.

Further, the user profiles 5 enable a communication channel with the users 4. This may be used to provide vouchers or free credits after a given number of purchases. Messages regarding specials relating to the beverage or to other products or merchandise can also be sent to the user 4's mobile phone 32/38. Once a user profile 5 has been registered, a user 4 can provide a seat number in the stadium for a given event. A profile interface will be able to guide the user 4 to the closest cup 11 vending machine and beverage dispensing point. The details of credit purchases against seat numbers will enable volume planning and distribution of beverage kegs to relevant dispensing points. Accordingly, a user 4 of system 1 is able to order a beverage from a particular seat and have it delivered. In an example, such a service might be provided to only a limited area, where seats are paid for at a premium, for example, or in privately owned boxes.

The example embodiments having been described, it is apparent that such have many varied applications. For example, the example embodiments may be applicable but not limited to connection to various devices, structures and articles. Additionally in an alternative, system 1 may employ Bluetooth Low Energy technology for communication or transfer of signals/information.

The present invention, in its various embodiments, configurations, and aspects, includes components, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices in the absence of items not depicted and/or described herein or in various embodiments, configurations, or aspects hereof, including in the absence of such items as may have been used in previous devices, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

I claim:

1. A beverage service system, comprising:
a payment facility adapted to receive a payment from a user and load the payment electronically, as a credit for cup units of a beverage, against a user profile created by the user, the user having a near field communication (NFC)-enabled device linked to their user profile,
a beverage dispenser connected to a computer processor, and
a credit receipt circuit in operative communication with the processor and having at least one reader provided in an immediate vicinity of the beverage dispenser, wherein the system is configured to dispense a cup unit of a beverage into each of a plurality of cups respectively having an electronically detectable, unique identification tag on transmission to the at least one credit receipt reader of a request to redeem a cup credit.

2. The system of claim 1, the system further configured to recognize an authorization interaction between the NFC-enabled device linked to a particular user profile and at least one cup mounted identification tag to effect authorization of at least one cup to receive a beverage unit, prior to processing the request to redeem a cup credit.

3. The system of claim 2, wherein the request to redeem a cup credit includes presenting, to the processor via the credit receipt circuit, a cup having the tag authorized to redeem a credit loaded against the user profile.

4. The system of claim 1, the system further configured to deduct a commensurate number of credits from the user profile on dispensing of authorized beverage units.

5. The system of claim 4, wherein the authorization interaction is initiated as a credit transfer instruction executed by the NFC-enabled device.

6. The system of claim 1, wherein the payment facility connected to an electronic platform which manages user profiles and profile credits.

7. The system of claim 1, wherein the beverage dispenser further includes at least one cup filling station with a cup filling nozzle having an actuator.

8. The system of claim 1, wherein a plurality of cups having distinct tags are linkable to a single user profile.

9. The system of claim 1, wherein
the request to redeem a cup credit is effected by a transfer of data to the at least one reader from the cup mounted tag, and
the credit transfer instruction is effected by a transfer of data from the NFC-enabled device.

10. The system of claim 2, wherein
the authorization interaction takes place through series communications from the NFC-enabled device through the cup mounted tag and to the credit receipt circuit, in which:
a first interaction occurs between the NFC-enabled device and cup mounted tag to provide the credit transfer instruction; and
a second interaction occurs between the cup mounted tag and the credit receipt reader to provide the request to redeem a cup credit.

11. The system of claim 2, wherein
the authorization interaction takes place through parallel communications, and
the at least one credit receipt reader further includes:
a first reader adapted to communicate with the cup mounted tag so as to provide the request to redeem a cup, and
a second reader adapted to communicate with the NFC-enabled device to provide the credit transfer instruction.

12. The system of claim 1, wherein the payment facility is online and accessed through the user profile.

13. The system of claim 1, wherein each cup includes a handle with an internal socket at an upper end and an external spigot at a lower end provided as a complementary fit to an internal socket of another cup for staggered or offset stacking to enable carrying of a plurality of beverage-filled cups.

14. The system of claim 1, wherein the beverage dispenser includes a plurality of filling stations, each configured to receive a cup and fill several cups independently.

15. The system of claim 14, wherein
each filling station includes an automated retractable filling nozzle for bottom filling of a cup,
each cup includes a bottom filling valve enabling the nozzle to penetrate the bottom of the cup therethrough, and
each filling station includes a dock configured to receive a bottom end of the cup and the system is adapted to effect automated filling of a docked cup.

16. The system of claim 1, wherein the cups are of limited reuse and the processor is adapted to:
count uses of individual cups and provide a signal on presentation of a cup after a predetermined number of uses indicating that cup replacement is required,
withhold filling of a cup after a predetermined number of uses and issue a signal directing removal of the cup from the beverage dispenser and to insert a replacement cup with a new tag, and
update the user profile by automatically linking the new tag to the user profile and deactivate the tag of the replaced cup from the user profile.

17. The system of claim 1, wherein the NFC-enabled device is embodied as an NFC-enabled mobile telephone or configured as a card with an NFC chip therein.

18. The system of claim 1, wherein
a mobile communication device of the user provides an interface to access the user profile and provide beverage ordering options to the user for a predefined number of cup units,
ordering information relating to the number of cup units required for refill, as selected by an option on the interface, is communicated to the processor for filling of cups having tags linked to the user profile,
the order is processed by the system once the request to redeem a cup credit is received and an authorization interaction recognized, and
the interface provides access to the payment facility.

19. A beverage service system, comprising:
a payment facility adapted to receive a payment from a user for cup units of a beverage, based on a user profile created by the user, the user having a near field communication (NFC)-enabled device linked to their user profile,
a beverage dispenser connected to a computer processor, and
a credit receipt circuit in operative communication with the processor and having at least one reader provided in an immediate vicinity of the beverage dispenser, wherein the system is configured to dispense a cup unit of a beverage into at least one cup having an electronically detectable, unique identification tag configured to interact with the at least one reader to request redemption of one or more cup credits,
wherein the request to redeem one or more cup credits includes presenting, to the processor via the credit receipt circuit, a cup having the tag authorized to redeem a credit loaded against the user profile.

20. A beverage service system, comprising:
a payment facility adapted to receive a payment from a user for cup units of a beverage, based on a user profile created by the user, the user having a near field communication (NFC)-enabled device linked to their user profile,
a beverage dispenser connected to a computer processor,
the system configured to recognize an authorization interaction between the NFC-enabled device linked to a particular user profile and to an electronically detectable, unique identification tag of at least one cup that is configured to interact with the at least one reader to request redemption of one or more cup credits so as to receive a beverage unit, and
a credit receipt circuit in operative communication with the processor and having at least one reader provided in an immediate vicinity of the beverage dispenser,
wherein the request to redeem one or more cup credits includes presenting, to the processor via the credit receipt circuit, the cup with its the tag authorized to redeem a credit loaded against the user profile.
